(19) United States
(12) Patent Application Publication
(10) Pub. No.: US 2026/0046734 A1
(43) Pub. Date: Feb. 12, 2026

(54) Mobility With Pre-Configuration of Handover Preparation Information at DUS

(71) Applicant: Apple Inc., Cupertino, CA (US)

(72) Inventors: Naveen Kumar R PALLE VENKATA, San Diego, CA (US); Alexander SIROTKIN, Hod Hasharon (IL); Fangli XU, Beijing (CN); Haijing HU, Los Gatos, CA (US); Yuqin CHEN, Beijing (CN)

(21) Appl. No.: 19/102,267

(22) PCT Filed: Aug. 8, 2022
(86) PCT No.: PCT/CN2022/110990

§ 371 Date: Feb. 7, 2025

(51) Int. Cl. H04W 36/32; H04W 36/00

(52) U.S. Cl. CPC H04W 36/32; H04W 36/0085

(57) ABSTRACT

Embodiments of the present disclosure relate to mobility with pre-configuration of handover preparation information at distributed unit (DUs). According to embodiments of the present disclosure, a central unit (CU) of a base station comprises a transceiver configured to communicate with a network; and a processor communicatively coupled to the transceiver and configured to perform operations. The operations comprise transmitting, to a second DU of the base station, handover preparation information for inter-DU mobility of a user equipment (UE); after transmitting the handover preparation information, receiving a request for the inter-DU mobility from a first DU of the base station serving the UE; and in accordance with a determination that the request for the inter-DU mobility is accepted, triggering the inter-DU mobility.

### TECHNICAL FIELD

Embodiments of the present disclosure generally relate to the field of telecommunications, and in particular, to mobility with pre-configuration of handover preparation information at distributed unit (DUs).

### BACKGROUND

A base station (BS) may comprise a central unit (CU) and one or more DUs. Operation of the DU may be partly controlled by the CU. The CU may terminate the F1 interface connected with the DU. The DU may support one or more cells. One cell is supported by only one DU. The DU may terminate the F1 interface connected with the CU.

The DU may serve one or more user equipments (UEs) directly connected to the DU. Based on measurements, a UE may perform an intra-DU mobility procedure so as to move from one cell provided by a DU to another cell provided by the DU. Alternatively, the UE may perform an inter-DU mobility procedure so as to move from a cell provided by one DU to a cell provided by another DU controlled by the same CU.

### SUMMARY

In general, example embodiments of the present disclosure provide a solution for mobility with pre-configuration of handover preparation information at distributed unit (DUs).

In a first aspect, there is provided a CU of a BS. The CU comprises a transceiver and a processor. The transceiver is configured to communicate with a network. The processor is communicatively coupled to the transceiver and configured to perform operations comprising: transmitting, to a second DU of the base station, handover preparation information for inter-DU mobility of a UE; after transmitting the handover preparation information, receiving a request for the inter-DU mobility from a first DU of the base station serving the UE; and in accordance with a determination that the request for the inter-DU mobility is accepted, triggering the inter-DU mobility.

In a second aspect, there is provided a DU of a BS. The DU comprises a transceiver and a processor. The transceiver is configured to communicate with a network. The processor is communicatively coupled to the transceiver and configured to perform operations comprising: receiving, a CU of the base station, handover preparation information for inter-DU mobility of a UE; and performing a random access procedure with the UE based on the handover preparation information.

In a third aspect, there is provided a baseband processor of a BS. The baseband processor is configured to perform operations comprising: transmitting, to a second DU of the base station, handover preparation information for inter-DU mobility of a UE; after transmitting the handover preparation information, receiving a request for the inter-DU mobility from a first DU of the base station serving the UE; and in accordance with a determination that the request for the inter-DU mobility is accepted, triggering the inter-DU mobility.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a signaling chart illustrating a process for mobility in accordance with some example embodiments of the present disclosure;

FIG. 3A illustrates a signaling chart illustrating a process for inter-DU mobility in accordance with some example embodiments of the present disclosure;

FIG. 3B illustrates an exemplary UE CONTEXT MODIFICATION REQUEST message in accordance with some example embodiments of the present disclosure;

FIG. 3C illustrates a signaling chart illustrating a process for inter-DU mobility in accordance with some other example embodiments of the present disclosure;

FIG. 3D illustrates an exemplary UE CONTEXT MODIFICATION REQUEST message in accordance with some other example embodiments of the present disclosure;

FIG. 4A illustrates a signaling chart illustrating a process for inter-DU mobility in accordance with still other example embodiments of the present disclosure;

FIG. 4B illustrates an exemplary UL RRC MESSAGE TRANSFER message in accordance with some example embodiments of the present disclosure;

FIG. 4C illustrates another exemplary UL RRC MESSAGE TRANSFER message in accordance with some example embodiments of the present disclosure;

FIG. 4D illustrates a signaling chart illustrating a process for inter-DU mobility in accordance with further example embodiments of the present disclosure;

FIG. 4E illustrates another exemplary UE CONTEXT MODIFICATION REQUIRED message in accordance with some example embodiments of the present disclosure;

FIG. 4F illustrates an exemplary configuration of L2 specific events in accordance with some example embodiments of the present disclosure;

FIG. 4G illustrates another exemplary configuration of L2 specific events in accordance with some other example embodiments of the present disclosure;

FIG. 5 illustrates a signaling chart illustrating a process for inter-DU mobility where handover preparation information is preconfigured in accordance with some example embodiments of the present disclosure;

FIG. 6 illustrates a signaling chart illustrating a process for inter-DU mobility with query with target DU in accordance with some other example embodiments of the present disclosure;

FIG. 7 illustrates a signaling chart illustrating a process for inter-DU mobility without query with target DU in accordance with still other example embodiments of the present disclosure;

FIG. 8A illustrates an exemplary IE for configurations of candidate cells for L2 mobility in accordance with some example embodiments of the present disclosure;

FIG. 8B illustrates an exemplary IE for configurations of candidate cells for L2 mobility which are included as part of conditional configuration in accordance with some example embodiments of the present disclosure;

FIG. 8C illustrates an exemplary IE for configurations of candidate cells for L2 mobility which are common to the examples of FIGS. 8A and 8B in accordance with some example embodiments of the present disclosure;

FIG. 8D illustrates an exemplary IE for configurations of candidate cells for L1 mobility and L2 mobility in accordance with some example embodiments of the present disclosure;

FIG. 8E illustrates an exemplary IE for configurations of candidate cells for L1 mobility which are included as part of conditional configuration in accordance with some example embodiments of the present disclosure;

FIG. 8F illustrates an exemplary IE for configurations of candidate cells for L2 mobility and L1 mobility which are common to the examples of FIGS. 8D and 8E in accordance with some example embodiments of the present disclosure;

FIG. 9A illustrates an exemplary IE for configuration for handling of the PDCP and the RLC in accordance with some example embodiments of the present disclosure;

FIG. 9B illustrates an exemplary IE for configuration for handling of the PDCP and the RLC in accordance with some other example embodiments of the present disclosure;

FIG. 9C illustrates an exemplary IE for configuration for handling of the PDCP and the RLC in accordance with still other example embodiments of the present disclosure;

FIG. 10 illustrates a flowchart illustrating an example method for mobility implemented at a CU of a BS in accordance with some example embodiments of the present disclosure;

FIG. 11 illustrates a flowchart illustrating an example method for mobility implemented at a target DU of a BS in accordance with some example embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (4C), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

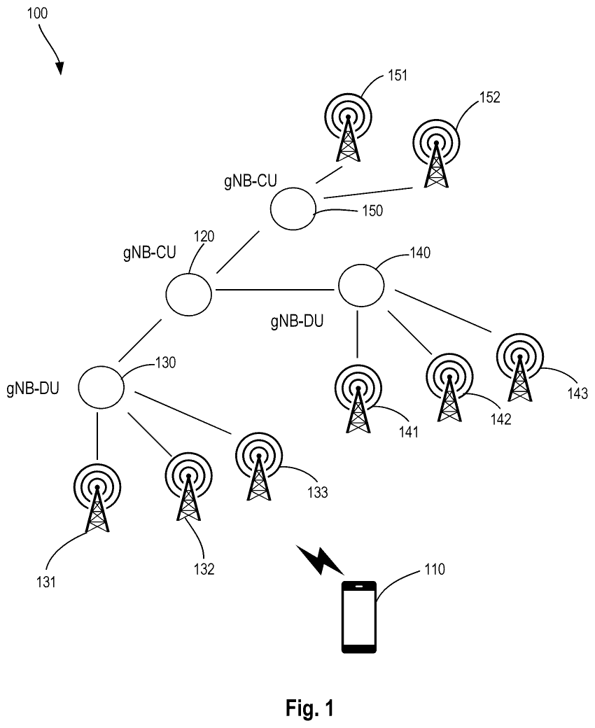

FIG. 1 shows an example communication network 100 in which embodiments of the present disclosure can be implemented. The network 100 may comprise a base station. The base station may comprise a CU and one or more DUs. In some embodiments, the base station may be a gNB, eNB and so on. In the example of FIG. 1, the base station is illustrated as a gNB. In such an example, the CU of the base station may be referred to as a gNB-CU, and the DU of the base station may be referred to as a gNB-DU.

As shown in FIG. 1, the network 100 may comprise a UE 110, gNB-CUs 120 and 150, a first gNB-DU 130 and a second gNB-DU 140. The first gNB-DU 130 and the second gNB-DU 140 are connected to the gNB-CU 120. Operations of the first gNB-DU 130 and the second gNB-DU 140 may be partly controlled by the gNB-CU 120. The gNB-CU 120 may terminate the F1 interface connected with each of the first gNB-DU 130 and the second gNB-DU 140. Each of the first gNB-DU 130 and the second gNB-DU 140 may terminate the F1 interface connected with the gNB-CU 120.

The gNB-CU 120 may be a logical node hosting at least one of radio resource control (RRC), service data adaption protocol (SDAP) and packet data convergence protocol (PDCP) protocols of the base station. The gNB-CU 150 may be a logical node hosting at least one of RRC, SDAP and PDCP protocols of another base station.

Each of the first gNB-DU 130 and the second gNB-DU 140 may be a logical node hosting at least one of radio link control (RLC), medium access control (MAC) and physical (PHY) layers of the base station.

Each of the first gNB-DU 130 and the second gNB-DU 140 may provide or support one or more cells. One cell is supported by only one DU. For example, the first gNB-DU 130 may provide cells 131, 132 and 133, and the second gNB-DU 140 may provide cells 141, 142 and 143.

The gNB-CU 150 may also provide or support one or more cells. For example, the gNB-CU 150 may provide cells 151 and 152.

It is to be understood that the numbers of UEs, CUs and DUs are only for the purpose of illustration without suggesting any limitations to the present disclosure. The network 100 may include any suitable number of UEs, CUs and DUs adapted for implementing implementations of the present disclosure.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (4C), the fourth generation (4G), 4.5G, the fifth generation (5G) communication protocols.

The UE 110 may access one cell provided by the first gNB-DU 130. For example, the UE 110 may be initially connected to the cell 133 provided by the first gNB-DU 130. Based on measurements, the UE 110 may perform an intra-DU mobility procedure so as to move from the cell 133 to another cell provided by the first gNB-DU 130. For example, the UE 110 may perform an intra-DU mobility procedure so as to move from the cell 133 to one of the cells 131 and 132. Hereinafter, the intra-DU mobility is also referred to as intra-gNB-DU mobility.

Alternatively, based on measurements, the UE 110 may perform an inter-DU mobility procedure so as to move from a cell provided by the first gNB-DU 130 to a cell provided by the second gNB-DU 140. For example, the UE 110 may perform an inter-DU mobility procedure so as to move from the cell 133 provided by the first gNB-DU 130 to one of the cells 141, 142 and 143 provided by the second gNB-DU 140. Hereinafter, the inter-DU mobility is also referred to as inter-gNB-DU mobility.

In some embodiments, the UE 110 may be in dual connectivity (DC) with the gNB-CUs 120 and 150. The intra-DU mobility procedure and the inter-DU mobility procedure may be allowed when the gNB-CU 120 is configured as a secondary node (SN) in a DC configuration while the gNB-CU 150 is configured as a master node (MN).

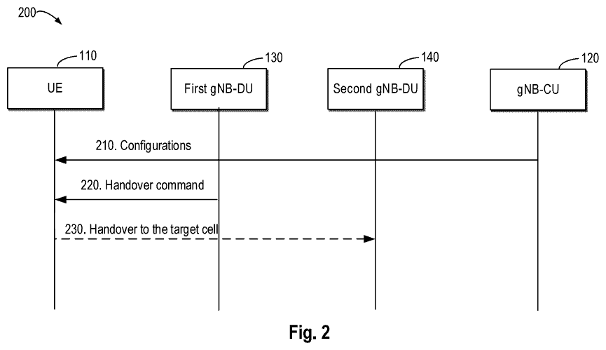

FIG. 2 illustrates a signaling chart illustrating a process 200 for mobility in accordance with some example embodiments of the present disclosure. For the purpose of discussion, the process 200 will be described with reference to FIG. 1. The process 200 may involve the UE 110, the gNB-CU 120, the first gNB-DU 130 and the second gNB-DU 140 in FIG. 1.

As shown in FIG. 2, the UE 110 receives 210, from the gNB-CU 120, at least one of configurations for a first set of candidate cells for intra-DU mobility or configurations for a second set of candidate cells for inter-DU mobility.

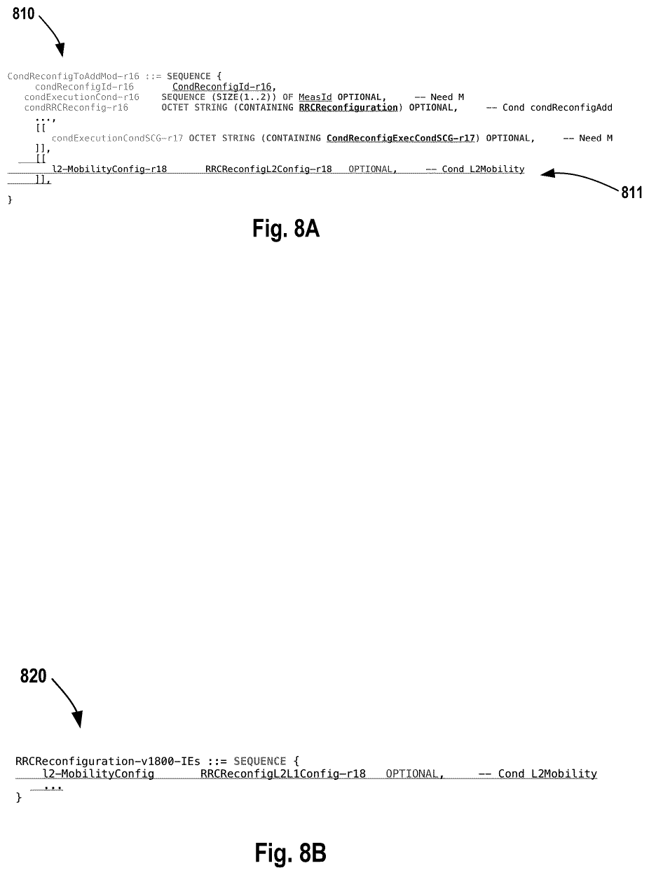

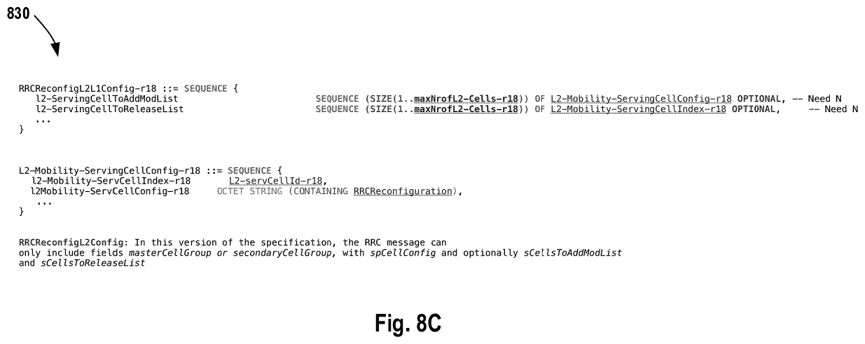

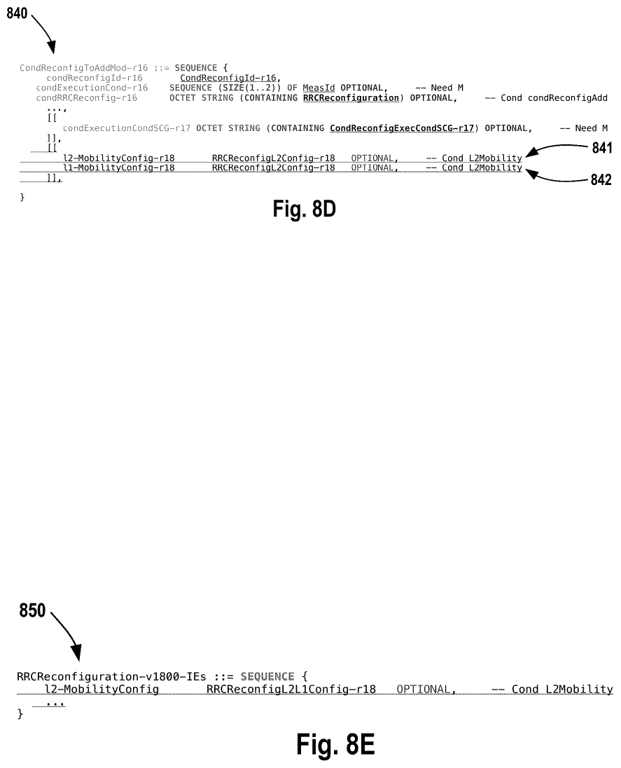

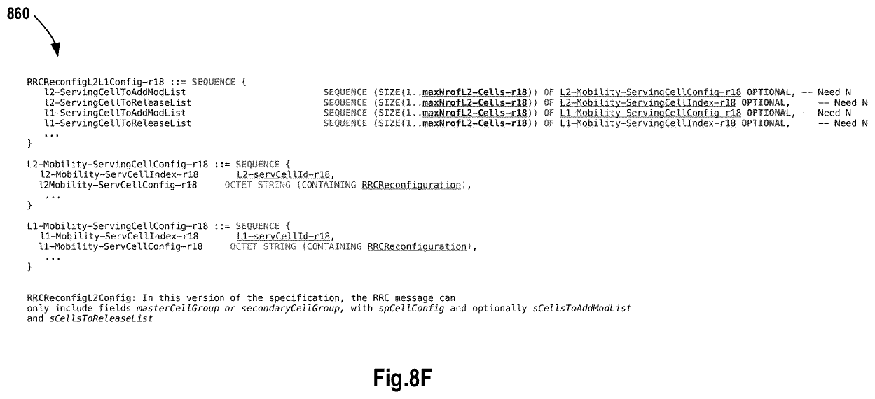

For example, in the embodiments where the UE 110 initially accesses the cell 133 provided by the first gNB-DU 130, the first set of candidate cells for intra-DU mobility may comprise the cells 131 and 132, and the second set of candidate cells for inter-DU mobility may comprise the cells 141, 142 and 143. Details of the configurations for the first set of candidate cells or configurations for the second set of candidate cells will be described later with reference to FIGS. 8A to 8F.

The UE 110 receives 220 a handover command from the first gNB-DU 130 serving the UE 110. The handover command comprises an index of a configuration of a target cell selected from the first set or the second set.

In turn, the UE 110 performs a handover to the target cell based on the handover command.

In the process 220, because the at least one of configurations for the first set of candidate cells or configurations for the second set of candidate cells are provided to the UE 110 before the handover, mobility latency may be reduced.

In embodiments where the target cell is selected from the first set of candidate cells for intra-DU mobility, the UE 110 may perform a handover to the target cell by performing an intra-DU mobility procedure.

In embodiments where the target cell is selected from the second set of candidate cells for inter-DU mobility, the UE 110 may perform 230 a handover to the target cell by performing an inter-DU mobility procedure.

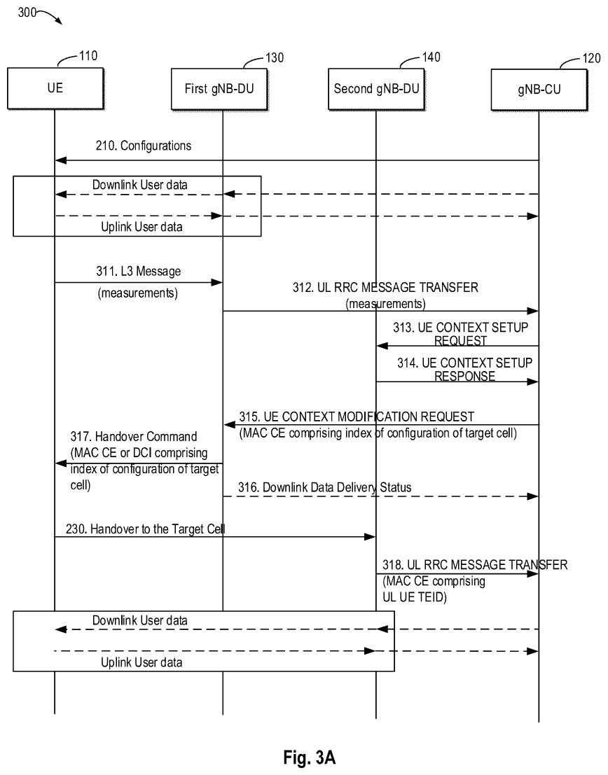

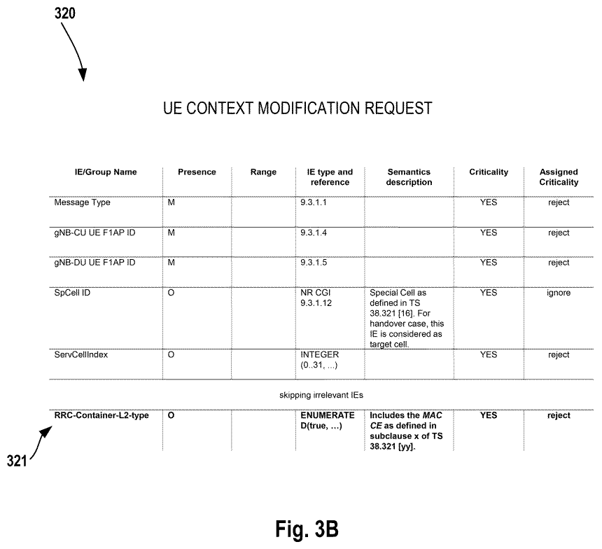

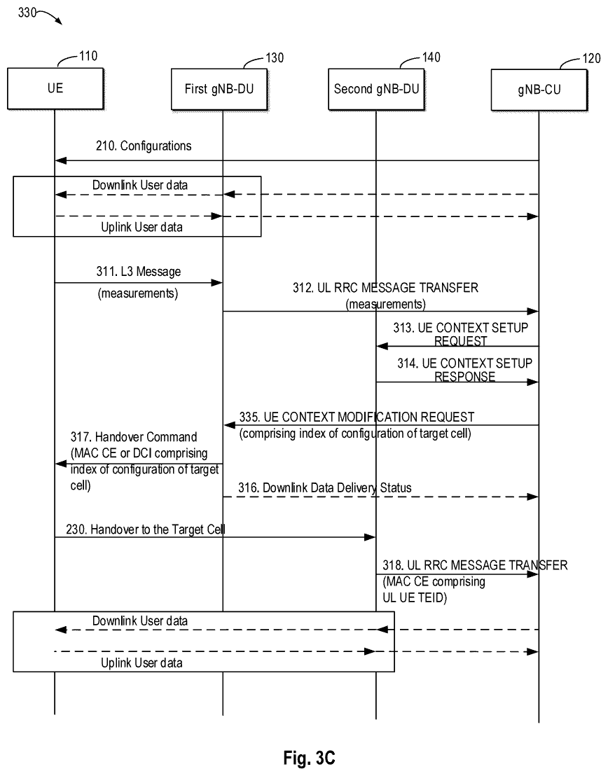

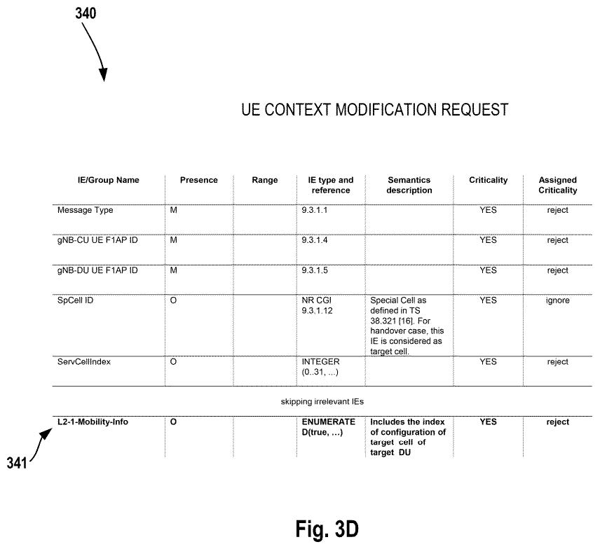

Hereinafter, some embodiments of the inter-DU mobility procedure will be described below with reference to FIGS. 3A to 6.

FIG. 3A illustrates a signaling chart illustrating a process 300 for inter-DU mobility in accordance with some example embodiments of the present disclosure. For the purpose of discussion, the process 300 will be described with reference to FIG. 1. The process 300 may involve the UE 110, the gNB-CU 120, the first gNB-DU 130 and the second gNB-DU 140 in FIG. 1. The process 300 may be considered an example implementation of the process 200.

Generally, in the process 300, the first gNB-DU 130 receives from the gNB-CU 120 a first message comprising a first MAC CE. The first MAC CE comprises the index of the configuration of the target cell. The handover command transmitted from the first gNB-DU 130 to the UE 110 comprises the first MAC CE. The first MAC CE comprises the index of the configuration of the target cell. Alternatively, the handover command comprises first downlink control information (DCI). The first DCI comprises the index of the configuration of the target cell.

In the process 300, the UE 110 may be initially connected to the cell 133 provided by the first gNB-DU 130. Thus, downlink user data to the UE 110 is forwarded to the gNB-CU 120 through the first gNB-DU 130. Also, uplink user data sent from the UE 110 is forwarded to the gNB-CU 120 through the first gNB-DU 130.

Based on measurements, the UE 110 may perform an inter-DU mobility procedure so as to move from the cell 133 to one of the cells 141, 142 and 143 provided by the second gNB-DU 140. In this regard, the first gNB-DU 130 may be referred to as a source gNB-DU, and the second gNB-DU 140 may be referred to as a target gNB-DU.

Specifically, as shown in FIG. 3A, similar to the process 200, the UE 110 receives 210, from the gNB-CU 120, at least one of configurations for a first set of candidate cells for intra-DU mobility or configurations for a second set of candidate cells for inter-DU mobility.

The UE 110 transmits 311 an L3 message comprising measurements to the gNB-DU 130. The gNB-DU 130 transmits 312 an UL RRC MESSAGE TRANSFER message to the gNB-CU 120 to convey the measurements.

The gNB-CU 120 transmits 313 an UE CONTEXT SETUP REQUEST message to the second gNB-DU 140 to create an UE context and setup one or more data bearers. The UE CONTEXT SETUP REQUEST message includes a HandoverPreparationInformation. In addition, the UE CONTEXT SETUP REQUEST message may comprise DL UE Tunnel Endpoint Identifier (TEID)

The second gNB-DU 314 responds to the gNB-CU 120 with an UE CONTEXT SETUP RESPONSE message.

The gNB-CU 120 transmits 315 the first message to the first gNB-DU 130. The first message may be used to provide UE context information changes to the first gNB-DU 130. For example, the first message may be a UE CONTEXT MODIFICATION REQUEST message. The UE CONTEXT MODIFICATION REQUEST message comprises the first MAC CE. The first MAC CE comprises the index of the configuration of the target cell. The first gNB-DU 130 also transmits 316 a Downlink Data Delivery Status frame to inform the gNB-CU 120 about the unsuccessfully transmitted downlink data to the UE 110.

Upon receiving the UE CONTEXT MODIFICATION REQUEST message from the gNB-CU 120, the first gNB-DU 130 transmits 317 the handover command to the UE 110. The handover command comprises the first MAC CE. The first MAC CE comprises the index of the configuration of the target cell. Alternatively, the handover command comprises first DCI. The first DCI comprises the index of the configuration of the target cell.

Upon receiving the handover command, the UE 110 performs 230 the handover to the target cell by performing an inter-DU mobility procedure. For example, the UE 110 may initiate a random access (RACH) procedure to the target cell.

The second gNB-DU 140 transmits 318 an UL RRC MESSAGE TRANSFER message to the gNB-CU 120. The UL RRC MESSAGE TRANSFER message may comprise an MAC CE comprising UL UE TEID.

Upon the handover, downlink user data to the UE 110 is forwarded to the gNB-CU 120 through the second gNB-DU 140. Also, uplink user data sent from the UE 110 is forwarded to the gNB-CU 120 through the second gNB-DU 140.

FIG. 3B illustrates an exemplary UE CONTEXT MODIFICATION REQUEST message 320 in accordance with some example embodiments of the present disclosure. The UE CONTEXT MODIFICATION REQUEST message 320 may be used in the process 300.

As shown in FIG. 3B, a new information element (IE) “RRC-Container-L2-type” 321 is introduced in the UE CONTEXT MODIFICATION REQUEST message 320. The IE “RRC-Container-L2-type” 321 may the first MAC CE. The first MAC CE comprises the index of the configuration of the target cell.

FIG. 3C illustrates a signaling chart illustrating a process 330 for inter-DU mobility in accordance with some other example embodiments of the present disclosure. For the purpose of discussion, the process 330 will be described with reference to FIG. 1. The process 330 may involve the UE 110, the gNB-CU 120, the first gNB-DU 130 and the second gNB-DU 140 in FIG. 1. The process 330 may be considered another example implementation of the process 200.

Generally, in the process 330, the first gNB-DU 130 receives from the gNB-CU 120 a first message. The first message comprises the index of the configuration of the target cell. The handover command transmitted from the first gNB-DU 130 to the UE 110 comprises the first MAC CE. The first MAC CE comprises the index of the configuration of the target cell. Alternatively, the handover command comprises first downlink control information (DCI). The first DCI comprises the index of the configuration of the target cell.

Actions at 210, 230, 311, 312, 313, 314, 316, 317 and 318 in the process 330 are the same as those in the process 300. Thus, details of the actions are omitted for brevity.

The process 330 is different from the process 300 in that upon receiving the UE CONTEXT SETUP RESPONSE message, the gNB-CU 120 transmits 335 to the first gNB-DU 130 the first message which comprises the index of the configuration of the target cell. For example, the first message may be a UE CONTEXT MODIFICATION REQUEST message. The UE CONTEXT MODIFICATION REQUEST message comprises the index of the configuration of the target cell.

FIG. 3D illustrates an exemplary UE CONTEXT MODIFICATION REQUEST message 340 in accordance with some other example embodiments of the present disclosure. The UE CONTEXT MODIFICATION REQUEST message 340 may be used in the process 330.

As shown in FIG. 3D, a new IE “L2-1-Mobility-Info” 341 is introduced in the UE CONTEXT MODIFICATION REQUEST message 340. The IE “L2-1-Mobility-Info” 341 may comprise the index of the configuration of the target cell.

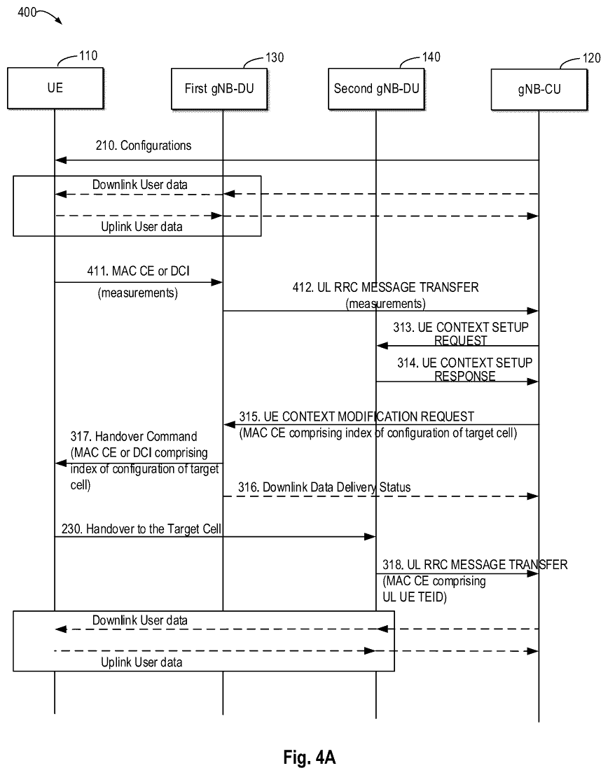

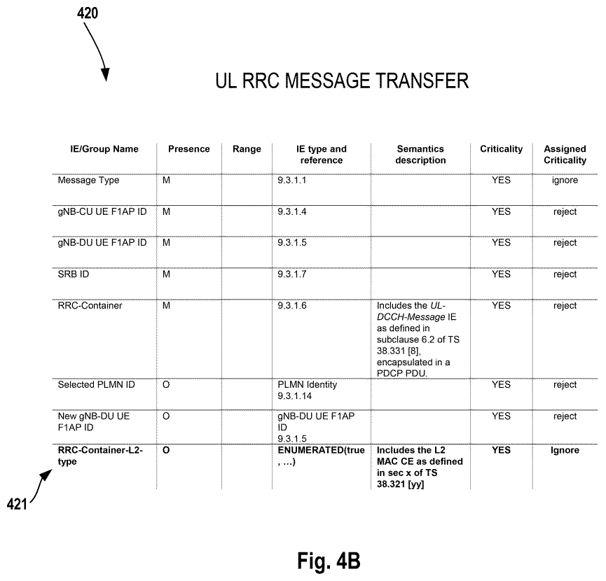

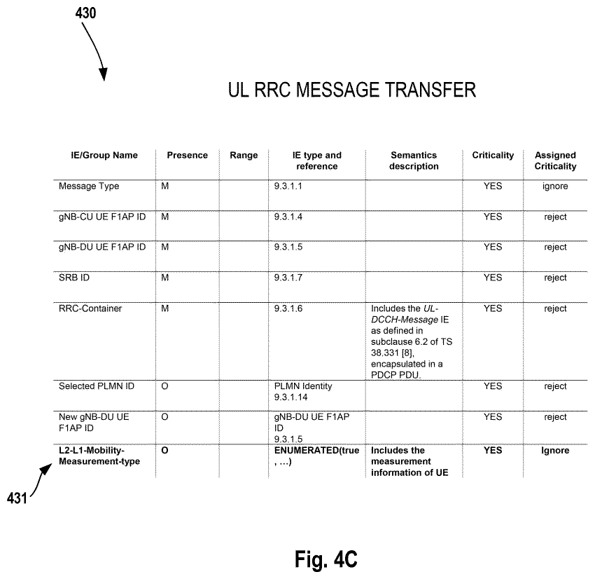

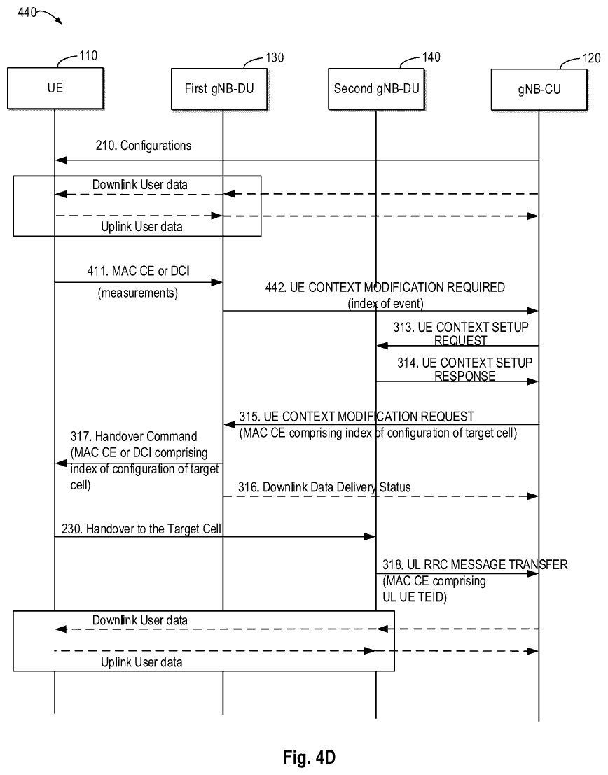

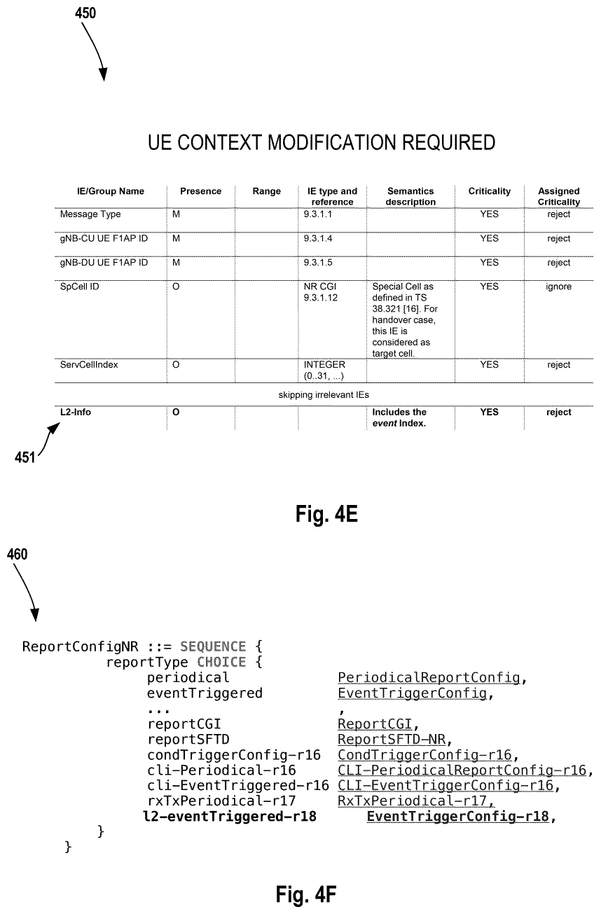

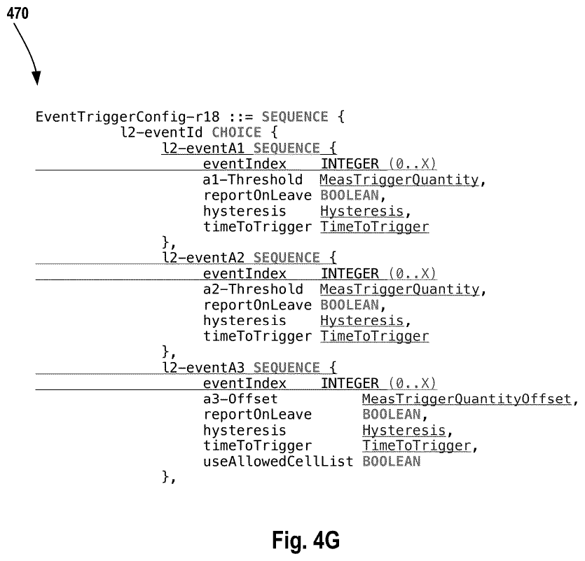

FIG. 4A illustrates a signaling chart illustrating a process 400 for inter-DU mobility in accordance with still other example embodiments of the present disclosure. For the purpose of discussion, the process 400 will be described with reference to FIG. 1. The process 400 may involve the UE 110, the gNB-CU 120, the first gNB-DU 130 and the second gNB-DU 140 in FIG. 1. The process 400 may be considered a further example implementation of the process 200.

Generally, in the process 400, before receiving the handover command, the UE 110 transmits a second MAC CE or second DCI to the first gNB-DU 130. The second MAC CE or the second DCI comprises measurements for at least one candidate cell in the first set of candidate cells for intra-DU mobility or in the second set of candidate cells for inter-DU mobility. Upon receiving the measurements, the first gNB-DU 130 may transmit a mobility request to the gNB-CU 120. The mobility request may comprise the second MAC CE comprising the measurements. Alternatively, the mobility request may comprise the measurements.

Actions at 210, 230, 313, 314, 316, 317 and 318 in the process 400 are the same as those in the process 300. Thus, details of the actions are omitted for brevity.

The process 400 is different from the process 300 in that the UE 110 transmits 411 a second MAC CE or second DCI to the first gNB-DU 130. The second MAC CE or second DCI comprises measurements for at least one candidate cell in the first set of candidate cells for intra-DU mobility or in the second set of candidate cells for inter-DU mobility. Upon receiving the measurements, the first gNB-DU 130 transmits 412 a mobility request to the gNB-CU 120.

In embodiments where the first gNB-DU 130 receives the measurements via the second MAC CE from the UE 110, the first gNB-DU 130 may identify using UE C-RNTI and DCCH logical channel. The first gNB-DU 130 may add the UE TEID to the content from the MAC CE.

In embodiments where the first gNB-DU 130 receives the measurements via the second MAC CE from the UE 110, the mobility request may comprise the second MAC CE comprising the measurements. Alternatively, the mobility request may comprise the measurements. For example, the first gNB-DU 130 may transmit the mobility request by transmitting an UL RRC MESSAGE TRANSFER message to the gNB-CU 120. The UL RRC MESSAGE TRANSFER message may be used to transfer the layer 3 message to the gNB-CU 120 over the F1 interface. The UL RRC MESSAGE TRANSFER message may comprise the second MAC CE comprising the measurements. Alternatively, the first gNB-DU 130 may parse the measurements in the second MAC CE from the UE 110 and provide the parsed measurements via the UL RRC MESSAGE TRANSFER message to the gNB-CU 120.

In embodiments where the first gNB-DU 130 receives the measurements via the second DCI from the UE 110, the first gNB-DU 130 may receive the measurements with PUCCH or with CSI punctured in PUSCH. In such embodiments, the mobility request may comprise the measurements. For example, the first gNB-DU 130 may transmit the mobility request by transmitting an UL RRC MESSAGE TRANSFER message to the gNB-CU 120. The first gNB-DU 130 may parse the measurements in the second DCI from the UE 110 and provide the parsed measurements via the UL RRC MESSAGE TRANSFER message to the gNB-CU 120. In such embodiments, the gNB-CU 120 does not need to implement the MAC specification.

FIG. 4B illustrates an exemplary UL RRC MESSAGE TRANSFER message 420 in accordance with some example embodiments of the present disclosure. The UL RRC MESSAGE TRANSFER message 420 may be used in the process 400.

As shown in FIG. 4B, a new IE “RRC-Container-L2-type” 421 is introduced in the UL RRC MESSAGE TRANSFER message 420. The IE “RRC-Container-L2-type” 421 may comprise the second MAC CE. The second MAC CE comprises the measurements for at least one candidate cell in the first set of candidate cells for intra-DU mobility or in the second set of candidate cells for inter-DU mobility.

FIG. 4C illustrates another exemplary UL RRC MESSAGE TRANSFER message 430 in accordance with some example embodiments of the present disclosure. The UL RRC MESSAGE TRANSFER message 430 may be used in the process 400.

As shown in FIG. 4C, a new IE “L2-L1-Mobility-Measurement-type” 431 is introduced in the UL RRC MESSAGE TRANSFER message 430. The IE “L2-L1-Mobility-Measurement-type” 431 may comprise the measurements for at least one candidate cell in the first set of candidate cells for intra-DU mobility or in the second set of candidate cells for inter-DU mobility.

FIG. 4D illustrates a signaling chart illustrating a process 440 for inter-DU mobility in accordance with further example embodiments of the present disclosure. For the purpose of discussion, the process 440 will be described with reference to FIG. 1. The process 440 may involve the UE 110, the gNB-CU 120, the first gNB-DU 130 and the second gNB-DU 140 in FIG. 1. The process 440 may be considered a further example implementation of the process 200.

Generally, in the process 440, the first gNB-DU 130 may receive, from the gNB-CU 120, at least one of a first configuration for a third set of events for layer 2 (L2) mobility or a second configuration for a fourth set of events for layer 1 (L1) mobility. If the measurements received from the UE 110 trigger at least one event in the third set or in the fourth set, the first gNB-DU 130 may transmit the mobility request to the gNB-CU 120. The mobility request may comprise an index of the at least one event. The first gNB-DU 130 may receive a response to the mobility request from the gNB-CU 120. The response comprises the index of the configuration of the target cell.

Actions at 210, 230, 313, 314, 316, 317 and 318 in the process 440 are the same as those in the process 300. The action at 411 in the process 440 is the same as that in the process 400. Thus, details of the actions are omitted for brevity.

The process 440 is different from the process 400 in that if the measurements received from the UE 110 trigger at least one event in the third set, the first gNB-DU 130 transmits 442 the mobility request to the gNB-CU 120.

For example, the first gNB-DU 130 may transmit the mobility request by transmitting a UE CONTEXT MODIFICATION REQUIRED message to the gNB-CU 120. The UE CONTEXT MODIFICATION REQUIRED message may be used to request the modification of a UE context. The UE CONTEXT MODIFICATION REQUIRED message may comprise an index of the at least one event. The UE CONTEXT MODIFICATION REQUIRED message may also comprise the measurements. In some embodiments, the first gNB-DU 130 may trigger the UE CONTEXT MODIFICATION REQUIRED message for the UE 110.

As a response to the UE CONTEXT MODIFICATION REQUIRED message, the gNB-CU 120 transmits 315, to the first gNB-DU 130, the UE CONTEXT MODIFICATION REQUEST message. The UE CONTEXT MODIFICATION REQUEST message comprises the first MAC CE. The first MAC CE comprises the index of the configuration of the target cell.

In some embodiments, the layer 2 or layer 1 message may contain a unique number or identifier that the UE 110 sends back in MSG3 as part of RACH on the second gNB-DU 140, which can get transferred to the gNB-CU 120 to confirm the handover.

FIG. 4E illustrates another exemplary UE CONTEXT MODIFICATION REQUIRED message 450 in accordance with some example embodiments of the present disclosure. The UE CONTEXT MODIFICATION REQUIRED message 450 may be used in the process 440.

As shown in FIG. 4E, a new IE “L2-Info” 451 is introduced in the UL RRC MESSAGE TRANSFER message 450. The IE “L2-Info” 451 may comprise the index of the at least one event triggered by the measurements.

In some embodiments, the UE 110 may receive, from the gNB-CU 120 or the first gNB-DU 130, at least one of the first configuration for the third set of events for layer 2 mobility or the second configuration for the fourth set of events for layer 1 mobility. The UE 110 may transmit, to the first gNB-DU 130, an index of at least one event in the third set or in the fourth set which is triggered by the measurements.

In some embodiments, the UE 110 may transmit the index of the at least one event together with the measurements. For example, the UE 110 may transmit, in the second MAC CE, the index of at least one event in the third set which is triggered by the measurements. For another example, the UE 110 may transmit, in the second DCI, the index of at least one event in the fourth set which is triggered by the measurements.

In some embodiments, the index of at least one event is associated with a physical cell identifier (PCI) of the target cell.

In some embodiments, legacy L3 events may be re-used.

In some embodiments, the UE 110 or the first gNB-DU 130 may be configured with L2 version or L1 version of the same L3 events.

In some embodiments, The MAC CE or DCI may carry the information about the legacy L3 events. Alternatively, new L2 or L1 specific events may be configured.

FIG. 4F illustrates an exemplary configuration 460 of L2 specific events in accordance with some example embodiments of the present disclosure. In the configuration 460, the same L3 events are used in L2.

FIG. 4G illustrates another exemplary configuration 470 of L2 specific events in accordance with some other example embodiments of the present disclosure. In the configuration 470, new events are defined in L2, with an index that is reported in MAC CE.

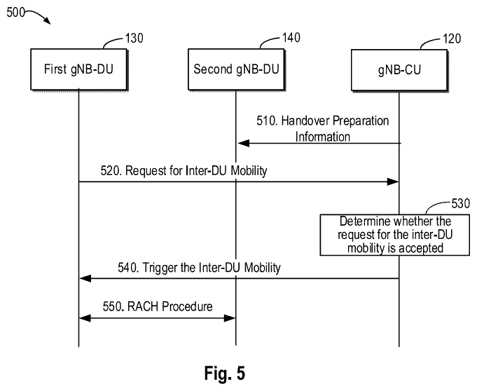

FIG. 5 illustrates a signaling chart illustrating a process 500 for inter-DU mobility where handover preparation information is preconfigured in accordance with some example embodiments of the present disclosure. For the purpose of discussion, the process 500 will be described with reference to FIG. 1. The process 500 may involve the gNB-CU 120, the first gNB-DU 130 and the second gNB-DU 140 in FIG. 1.

As shown in FIG. 5, the gNB-CU 120 transmits 510, to the second gNB-DU 140, handover preparation information for inter-DU mobility of the UE 110 before a start of handover. Accordingly, the second gNB-DU 140 receives the handover preparation information from the gNB-CU 120 before the start of handover.

After transmitting the handover preparation information, the gNB-CU 120 receives 520 a request for the inter-DU mobility from the first gNB-DU 130 serving the UE 110. In other words, before receiving the request for the inter-DU mobility from the first gNB-DU 130 (i.e., before a start of handover), the gNB-CU 120 transmits the handover preparation information to the second gNB-DU 140.

In turn, the gNB-CU 120 determines 530 whether the request for the inter-DU mobility is accepted. If the request for the inter-DU mobility is accepted, the gNB-CU 120 triggers 540 the inter-DU mobility.

In some embodiments, the handover preparation information comprises information about at least one of the following: context of the UE 110, or a data bearer to be established between the UE 110 and the second gNB-DU 140. Thus, upon receiving the handover preparation information, the context of the UE 110 may be created and the data bearer may be set up.

In the process 500, because the gNB-CU 120 transmits the handover preparation information to the second gNB-DU 140 before the start of handover, the latency for creating the context of the UE 110 and setting up the data bearer may be reduced.

In some embodiments, before the start of handover, the gNB-CU 120 may transmit the handover preparation information to all the candidate target gNB-DUs controlled by the gNB-CU 120.

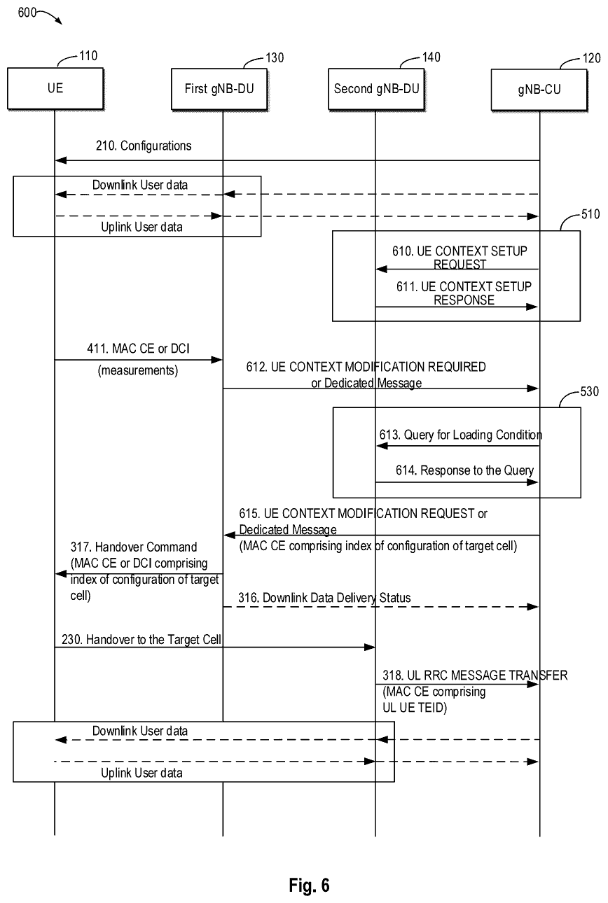

FIG. 6 illustrates a signaling chart illustrating a process 600 for inter-DU mobility with query with target DU in accordance with some other example embodiments of the present disclosure. For the purpose of discussion, the process 600 will be described with reference to FIG. 1. The process 600 may involve the UE 110, the gNB-CU 120, the first gNB-DU 130 and the second gNB-DU 140 in FIG. 1. The process 600 may be considered an example implementation of the process 500 or 200.

Generally, in the process 600, before receiving the request for the inter-DU mobility from the first gNB-DU 130 (i.e., before a start of handover), the gNB-CU 120 transmits the handover preparation information to the second gNB-DU 140. In addition, upon receiving the request for the inter-DU mobility, the gNB-CU 120 transmits a query for loading condition to the second gNB-DU 140 so as to determine whether the request for the inter-DU mobility is accepted. If the request for the inter-DU mobility is accepted, the gNB-CU 120 triggers 540 the inter-DU mobility.

The second gNB-DU 140 performs 550 a random access (RACH) procedure with the UE 110 based on the handover preparation information.

Actions at 210, 230, 316, 317, and 318 in the process 600 are the same as those in the process 300. Action at 411 in the process 600 is the same as that in the process 400. Thus, details of the actions are omitted for brevity.

The process 600 is different from the processes 300 and 400 in that before receiving the request for the inter-DU mobility from the first gNB-DU 130 (i.e., before the start of handover), the gNB-CU 120 transmits 600 the handover preparation information to the second gNB-DU 140. For example, the gNB-CU 120 may transmit a UE CONTEXT SETUP REQUEST message to the second gNB-DU 140. The UE CONTEXT SETUP REQUEST message comprises the handover preparation information. The second gNB-DU 140 may transmit 611 a UE CONTEXT SETUP RESPONSE message to the gNB-CU 120 to confirm the reception of the handover preparation information.

The first gNB-DU 130 transmits the request for the inter-DU mobility by transmitting 612 a UE CONTEXT MODIFICATION REQUIRED message or dedicated message. The UE CONTEXT MODIFICATION REQUIRED message or dedicated message may comprise the measurements of the UE 110. Alternatively or additionally, the UE CONTEXT MODIFICATION REQUIRED message or dedicated message may comprise the index of the at least one event triggered by the measurements.

Upon receiving the request for the inter-DU mobility, the gNB-CU 120 transmits 613 a query for loading condition to the second gNB-DU 140 so as to determine whether the request for the inter-DU mobility is accepted. For example, the gNB-CU 120 may transmit, to the second gNB-DU 140, a UE CONTEXT SETUP REQUEST message or a first dedicated message comprising the query.

The gNB-CU 120 receives 614 a response to the query from the second gNB-DU 140. The response comprises an indication of the loading condition. For example, the gNB-CU 120 may receive, from the second gNB-DU 140, a UE CONTEXT SETUP RESPONSE message or a second dedicated message comprising the response to the query.

The gNB-CU 120 may determine whether the loading condition is below a threshold. If the loading condition is below the threshold, the gNB-CU 120 may determine that the request for the inter-DU mobility is accepted.

If the request for the inter-DU mobility is accepted, the gNB-CU 120 transmits 615 a UE CONTEXT MODIFICATION REQUEST or dedicated message to the first gNB-DU 130 so as to trigger the inter-DU mobility. The UE CONTEXT MODIFICATION REQUEST or dedicated message may comprise the MAC CE comprising the index of configuration of the target cell.

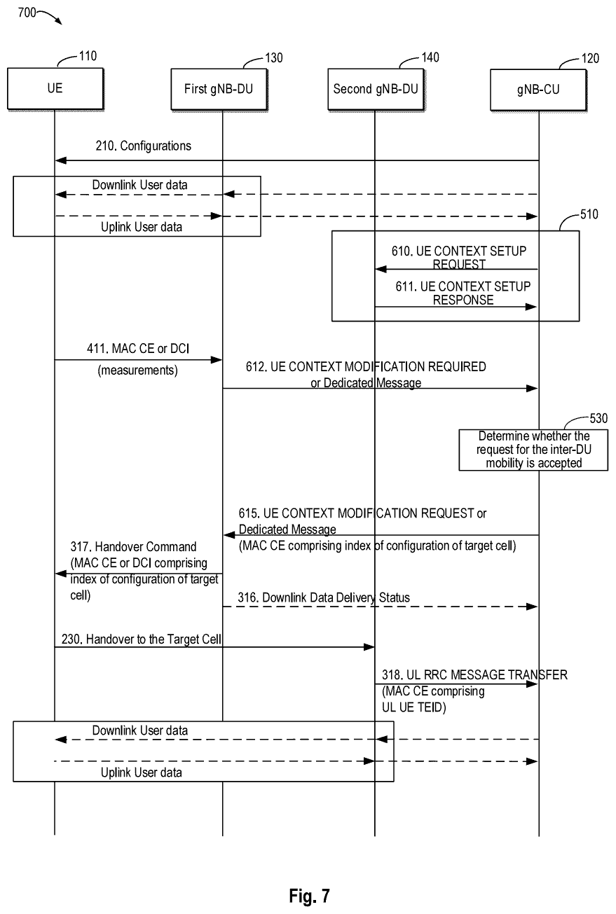

FIG. 7 illustrates a signaling chart illustrating a process 700 for inter-DU mobility without query with target DU in accordance with some other example embodiments of the present disclosure. For the purpose of discussion, the process 700 will be described with reference to FIG. 1. The process 700 may involve the UE 110, the gNB-CU 120, the first gNB-DU 130 and the second gNB-DU 140 in FIG. 1. The process 700 may be considered an example implementation of the process 500 or 200.

The process 700 is similar to the process 600. The process 700 is different from the process 600 in that the actions at 613 and 614 are omitted. For example, in small cell cases, the actions at 613 and 614 may be omitted. In other words, in the process 700, the gNB-CU 120 may determine 530 accept or reject the request for the inter-DU mobility without transmitting the query for loading condition to the second gNB-DU 140 or receiving the response to the query from the second gNB-DU 140.

Hereinafter, some embodiments of configurations of candidate cells will be described below with reference to FIG. 8A to 8F. The configurations of candidate cells may comprise at least one of the configurations for the first set of candidate cells for intra-DU mobility or configurations for the second set of candidate cells for inter-DU mobility.

In some embodiments, the gNB-CU 120 may transmit an RRC message to the UE 110. The RRC message comprises the at least one of configurations for the first set of candidate cells for intra-DU mobility or configurations for the second set of candidate cells for inter-DU mobility. Thus, the configurations may be provided in a secure way.

The configurations of candidate cells may be provided before the handover, and the configurations are not assumed to be changed during the handover. The configurations of candidate cells may be changed when there is no handover.

FIG. 8A illustrates an exemplary IE 810 for configurations of candidate cells for L2 mobility in accordance with some example embodiments of the present disclosure. In the example of FIG. 8A, separate configurations of candidate cells for L2 mobility are used, which may be included as part of conditional configuration. The configurations of candidate cells for L2 mobility comprise a list of candidate L2 cells, as shown by 811.

FIG. 8B illustrates an exemplary IE 820 for configurations of candidate cells for L2 mobility which are included as part of conditional configuration in accordance with some example embodiments of the present disclosure. In the example of FIG. 8B, configurations of candidate cells for L2 mobility are included as part of conditional configuration, where L2 mobility is conditional. This helps with UE initiated.

In the examples of FIGS. 8A and 8B, the configurations of candidate cells may be constrained to only contain the serving cell configurations. DC configuration is allowed.

FIG. 8C illustrates an exemplary IE 830 for configurations of candidate cells for L2 mobility in accordance with some example embodiments of the present disclosure. The configurations of candidate cells for L2 mobility in FIG. 8C are common to the examples of FIGS. 8A and 8B.

FIG. 8D illustrates an exemplary IE 840 for configurations of candidate cells for L1 mobility and L2 mobility in accordance with some example embodiments of the present disclosure. In the example of FIG. 8D, configurations of candidate cells for L1 mobility and L2 mobility may be included as part of conditional configuration. The configurations of candidate cells for L2 mobility comprise a list of candidate L2 cells, as shown by 841. The configurations of candidate cells for L1 mobility comprise a list of candidate L1 cells, as shown by 842.

FIG. 8E illustrates an exemplary IE 850 for configurations of candidate cells for L1 mobility which are included as part of conditional configuration in accordance with some example embodiments of the present disclosure. In the example of FIG. 8E, configurations of candidate cells for L1 mobility are included as part of conditional configuration, where L1 mobility is conditional. This helps with UE initiated.

In the examples of FIGS. 8D and 8E, the configurations of candidate cells may be constrained to only contain the serving cell configurations. DC configuration is allowed.

FIG. 8F illustrates an exemplary IE 860 for configurations of candidate cells for L2 mobility and L1 mobility in accordance with some example embodiments of the present disclosure. The configurations of candidate cells for L2 mobility in FIG. 8F are common to the examples of FIGS. 8D and 8E.

In some embodiments, the UE 110 may receive, from the gNB-CU 120 or the first gNB-DU 130, a third configuration for handling of packet data convergence protocol (PDCP) and radio link control (RLC).

In such embodiments, the third configuration for handling of the PDCP and the RLC may be used for a first candidate cell in the second set of candidate cells for inter-DU mobility. In other words, the third configuration for handling of the PDCP and the RLC may be used for each target cell. Alternatively, the third configuration for handling of the PDCP and the RLC may be used for a data radio bearer (DRB) or a signaling radio bearer (SRB) in the first candidate cell in the second set.

In such embodiments, the UE 110 may receive the third configuration for handling of the PDCP and the RLC together with the configurations for the second set of candidate cells for inter-DU mobility. In such embodiments, the third configuration for handling of the PDCP and the RLC may be changed after handover. Legacy delta handling applies. Thus, the field needs to be present as separate field.

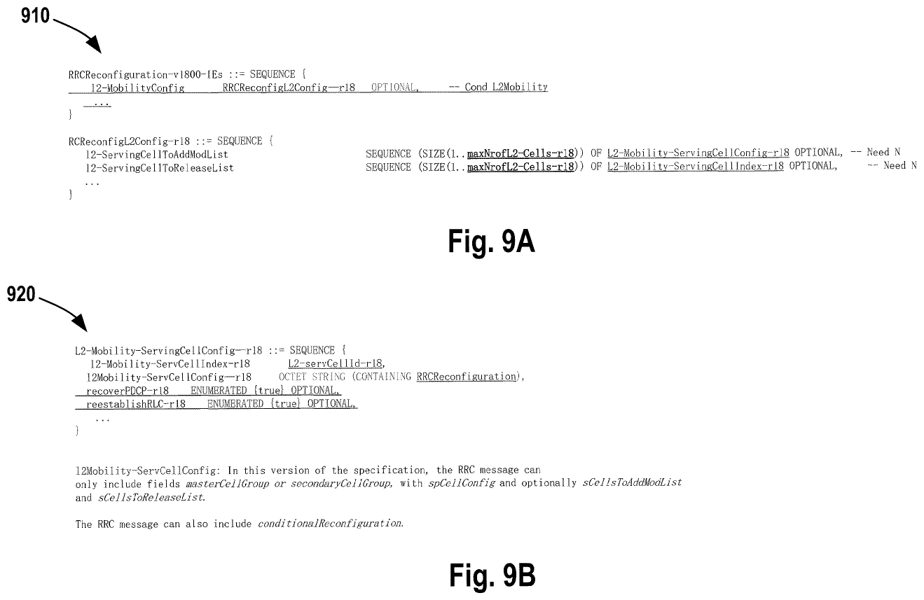

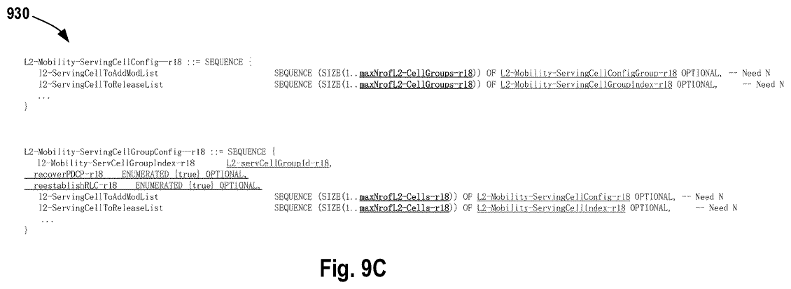

FIG. 9A illustrates an exemplary IE 910 for configuration for handling of the PDCP and the RLC in accordance with some example embodiments of the present disclosure. The exemplary IE 910 comprises the third configuration for handling of the PDCP and the RLC together with the configurations for the second set of candidate cells for inter-DU mobility.

In some embodiments, the handover command (in L2 or L1) may comprise the third configuration for handling of the PDCP and the RLC. In such embodiments, the UE 110 may just follow the handover command. This is simpler or fool-proof. For the handover command in L2, the MAC CE may comprise the third configuration for handling of the PDCP and the RLC. For the handover command in L1, the DCI may comprise the third configuration for handling of the PDCP and the RLC.

FIG. 9B illustrates an exemplary IE 920 for configuration for handling of the PDCP and the RLC in accordance with some other example embodiments of the present disclosure. The exemplary IE 910 may be included in the handover command from the first gNB-DU 130.

In some embodiments, the third configuration for handling of the PDCP and the RLC may be used for a group of candidate cells in the first set of candidate cells for intra-DU mobility. In such embodiments, the third configuration for handling of the PDCP and the RLC may be included as a set of PCIs which are part of intra-DU mobility.

In such embodiments, grouping of candidate cells may be with a bitmap or explicit group sets. Such embodiments help with UE saving the configuration such that subsequent L2 mobility (without network information) does not need re-configurations.

FIG. 9C illustrates an exemplary IE 930 for configuration for handling of the PDCP and the RLC in accordance with still other example embodiments of the present disclosure. In the exemplary IE 930, the third configuration for handling of the PDCP and the RLC is used for a group of candidate cells in the first set of candidate cells for intra-DU mobility.

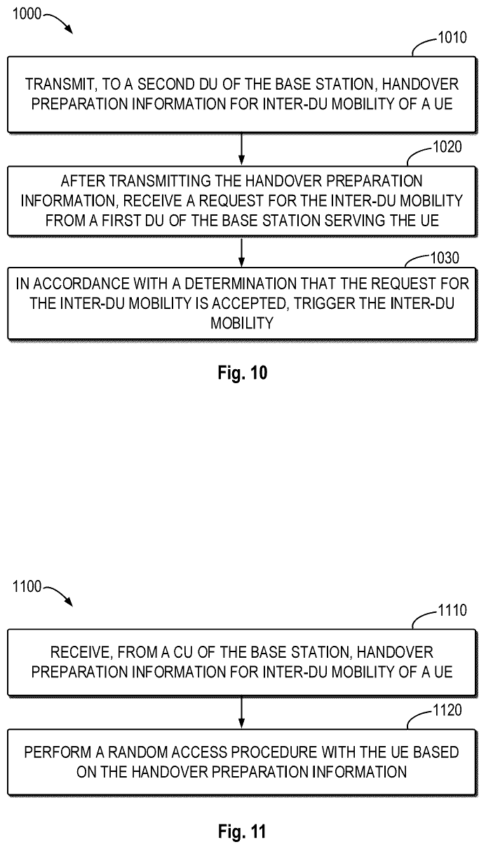

FIG. 10 illustrates a flowchart illustrating an example method 1000 for mobility according to some embodiments of the present disclosure. For the purpose of discussion, the method 1000 will be described from the perspective of the CU 120 with reference to FIG. 1.

At block 1010, the CU 120 transmits, to a second DU of the base station, handover preparation information for inter-DU mobility of a UE.

At block 1020, after transmitting the handover preparation information, the CU 120 receives a request for the inter-DU mobility from a first DU of the base station serving the UE.

At block 1030, in accordance with a determination that the request for the inter-DU mobility is accepted, the CU 120 triggers the inter-DU mobility.

In some embodiments, the handover preparation information comprises information about at least one of the following: context of the UE, or a data bearer to be established between the UE and the second DU.

In some embodiments, the method 1000 further comprises: determining whether the request for the inter-DU mobility is accepted. Determining whether the request for the inter-DU mobility is accepted comprising: transmitting a query for loading condition to the second DU; receiving a response to the query from the second DU, the response comprising an indication of the loading condition; and in accordance with a determination that the loading condition is below a threshold, determining that the request for the inter-DU mobility is accepted.

In some embodiments, transmitting the query for loading condition to the second DU comprises: transmitting, to the second DU, a UE CONTEXT SETUP REQUEST message or a first dedicated message comprising the query.

In some embodiments, receiving the response to the query from the second DU comprises: receiving, from the second DU, a UE CONTEXT SETUP RESPONSE message or a second dedicated message comprising the response to the query.

In some embodiments, the method 1000 further comprises: transmitting, to the UE, at least one of configurations for a first set of candidate cells for intra-DU mobility or configurations for a second set of candidate cells for the inter-DU mobility.

In some embodiments, triggering the inter-DU mobility comprises: selecting a target cell from the first set or the second set for handover; and transmitting an index of a configuration of the target cell to the first DU.

In some embodiments, transmitting the index of the configuration of the target cell to the first DU comprises: transmitting, to the first DU, a first message comprising one of the following: a first medium access control control element (MAC CE) comprising the index of the configuration of the target cell, or the index of the configuration of the target cell.

In some embodiments, the request for the inter-DU mobility comprising one of the following: a second MAC CE comprising measurements for at least one candidate cell in second set, or the measurements.

In some embodiments, the method 1000 further comprises: receiving, from the first DU, an index of at least one event in a third set of events which is triggered by the measurements, the third set of events being for layer 2 mobility.

In some embodiments, the index of at least one event is associated with a physical cell identifier (PCI) of the target cell.

In some embodiments, the method 1000 further comprises: transmitting, to the first DU, at least one of a first configuration for a third set of events for layer 2 mobility.

In some embodiments, the request for the inter-DU mobility comprises the index of the at least one event.

In some embodiments, transmitting the index of the configuration of the target cell to the first DU comprises: transmitting, to the first DU, a response to the request for the inter-DU mobility, the response comprising the index of the configuration of the target cell.

In some embodiments, the method 1000 further comprises: transmitting, to the UE, a third configuration for handling of packet data convergence protocol (PDCP) and radio link control (RLC).

In some embodiments, the third configuration for handling of the PDCP and the RLC is used for at least one of the following: a first candidate cell in the second set, a data radio bearer or a signaling radio bearer in the first candidate cell in the second set, or a group of candidate cells in the first set.

FIG. 11 illustrates a flowchart illustrating an example method 1100 for mobility according to some embodiments of the present disclosure. For the purpose of discussion, the method 1100 will be described from the perspective of the DU 140 with reference to FIG. 1.

At block 1110, the DU 140 receives, from a CU of the base station, handover preparation information for inter-DU mobility of a UE before a start of handover.

At block 1120, the DU 140 performs a random access procedure with the UE based on the handover preparation information.

In some embodiments, the handover preparation information comprises information about at least one of the following: context of the UE, or a data bearer to be established between the UE and the DU.

In some embodiments, the method 1100 further comprises: receiving a query for loading condition from the CU; and transmitting a response to the query to the CU, the response comprising an indication of the loading condition.

In some embodiments, receiving the query for loading condition from the CU comprises: receiving, from the CU, a UE CONTEXT SETUP REQUEST message or a first dedicated message comprising the query.

In some embodiments, transmitting the response to the query to the CU comprises: transmitting, to the CU, a UE CONTEXT SETUP RESPONSE message or a second dedicated message comprising the response to the query.

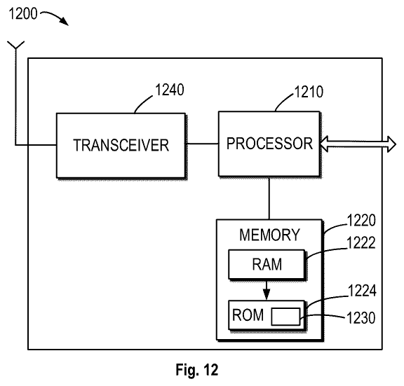

FIG. 12 is a simplified block diagram of a device 1200 that is suitable for implementing embodiments of the present disclosure. For example, the UE 110, the gNB-CU 120, the first gNB-DU 130 or the second gNB-DU 140 can be implemented by the device 1200. As shown, the device 1200 includes a processor 1210, a memory 1220 coupled to the processor 1210, and a transceiver 1240 coupled to the processor 1210.

The transceiver 1240 is for bidirectional communications. The transceiver 1240 is coupled to at least one antenna to facilitate communication. The transceiver 1240 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any method of the disclosure as discussed with reference to FIGS. 10 to 11. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1000 as described above with reference to FIG. 10 and/or the method 1100 as described above with reference to FIG. 11.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A central unit (CU) of a base station, comprising:
a transceiver configured to communicate with a user equipment (UE); and
a processor communicatively coupled to the transceiver and configured to perform operations comprising:
transmitting, to a second distributed unit (DU) of the base station, handover preparation information for inter-DU mobility of the UE;
after transmitting the handover preparation information, receiving a request for the inter-DU mobility from a first DU of the base station serving the UE; and
in accordance with a determination that the request for the inter-DU mobility is accepted, triggering the inter-DU mobility.

2. The CU of claim 1, wherein the handover preparation information comprises information about at least one of the following:
context of the UE, or
a data bearer to be established between the UE and the second DU.

3. The CU of claim 1, wherein the operations further comprises:
determining whether the request for the inter-DU mobility is accepted, comprising:
transmitting a query for loading condition to the second DU;
receiving a response to the query from the second DU, the response comprising an indication of the loading condition; and
in accordance with a determination that the loading condition is below a threshold, determining that the request for the inter-DU mobility is accepted.

4. The CU of claim 3, wherein transmitting the query for loading condition to the second DU comprises:
transmitting, to the second DU, a UE CONTEXT SETUP REQUEST message or a first dedicated message comprising the query.

5. The CU of claim 3, wherein receiving the response to the query from the second DU comprises:
receiving, from the second DU, a UE CONTEXT SETUP RESPONSE message or a second dedicated message comprising the response to the query.

6. The CU of claim 1, wherein the operations further comprises:
transmitting, to the UE, at least one of configurations for a first set of candidate cells for intra-DU mobility or configurations for a second set of candidate cells for the inter-DU mobility.

7. The CU of claim 6, wherein triggering the inter-DU mobility comprises:
selecting a target cell from the first set or the second set for handover; and
transmitting an index of a configuration of the target cell to the first DU.

8. The CU of claim 7, wherein transmitting the index of the configuration of the target cell to the first DU comprises:
transmitting, to the first DU, a first message comprising one of the following:
a first medium access control control element (MAC CE) comprising the index of the configuration of the target cell, or
the index of the configuration of the target cell.

9. The CU of claim 1, wherein the request for the inter-DU mobility comprising one of the following:
a second MAC CE comprising measurements for at least one candidate cell in second set, or
the measurements.

10. The CU of claim 9, wherein the operations further comprises:
receiving, from the first DU, an index of at least one event in a third set of events which is triggered by the measurements, the third set of events being for layer 2 mobility.

11. (canceled)

12. The CU of claim 9, wherein the operations further comprises:
transmitting, to the first DU, at least one of a first configuration for a third set of events for layer 2 mobility.

13. (canceled)

14. The CU of claim 13, wherein transmitting the index of the configuration of the target cell to the first DU comprises:
transmitting, to the first DU, a response to the request for the inter-DU mobility, the response comprising the index of the configuration of the target cell.

15. The CU of claim 1, wherein the operations further comprises:
transmitting, to the UE, a third configuration for handling of packet data convergence protocol (PDCP) and radio link control (RLC).

16. The CU of claim 15, wherein the third configuration for handling of the PDCP and the RLC is used for at least one of the following:
a first candidate cell in the second set,
a data radio bearer or a signaling radio bearer in the first candidate cell in the second set, or
a group of candidate cells in the first set.

17. A distributed unit (DU) of a base station, comprising:
a transceiver configured to communicate with a user equipment (UE); and
a processor communicatively coupled to the transceiver and configured to perform operations comprising:
receiving, from a central unit (CU) of the base station, handover preparation information for inter-DU mobility of the UE; and
performing a random access procedure with the UE based on the handover preparation information.

18. The DU of claim 17, wherein the handover preparation information comprises information about at least one of the following:
context of the UE, or
a data bearer to be established between the UE and the DU.

19. The DU of claim 17, wherein the operations further comprises:
receiving a query for loading condition from the CU; and
transmitting a response to the query to the CU, the response comprising an indication of the loading condition.

20. The DU of claim 19, wherein receiving the query for loading condition from the CU comprises:
receiving, from the CU, a UE CONTEXT SETUP REQUEST message or a first dedicated message comprising the query.

21. The DU of claim 19, wherein transmitting the response to the query to the CU comprises:
transmitting, to the CU, a UE CONTEXT SETUP RESPONSE message or a second dedicated message comprising the response to the query.

22. A baseband processor of a base station configured to perform operations comprising:
transmitting, to a second distributed unit (DU) of the base station, handover preparation information for inter-DU mobility of a user equipment (UE);
after transmitting the handover preparation information, receiving a request for the inter-DU mobility from a first DU of the base station serving the UE; and
in accordance with a determination that the request for the inter-DU mobility is accepted, triggering the inter-DU mobility.
